(19) United States
(12) Patent Application Publication
(10) Pub. No.: US 2009/0033006 A1
(43) Pub. Date: Feb. 5, 2009

(54) Processing method for graphite piece

(76) Inventor: Chin-Fu Horng, Lu Chou City (TW)

Correspondence Address: BIRCH STEWART KOLASCH & BIRCH, PO BOX 747, FALLS CHURCH, VA, 22040-0747, US

(21) Appl. No.: 11/882,317

(22) Filed: Jul. 31, 2007

(51) Int. Cl. B28B 1/30

(52) U.S. Cl. 264/643

(57) ABSTRACT

A processing method for graphite piece, and comprising the steps of: using a pair of male and female dies to sandwich a graphite material in between the pair of dies and cut the graphite material to become the graphite piece with the specific figure. The male die and the female die continuously applying a force onto the graphite piece in order to form a predetermined second thickness by a backform disposed between the pair of male and female dies. It makes the density of graphite piece increase and promote the efficiency of conducting. Furthermore, bending the bent portion of graphite piece continuously can solve the problems of bent graphite piece with low density resulted in inefficiency. Moreover, after the radiator embedding in the surface of the graphite piece, bending the graphite piece continuously can make the radiator firmly connected to the graphite piece.

### BACKGROUND OF THE INVENTION

1. Field of the Invention

The present invention relates to a processing method for graphite piece, and more particularly to a processing method for manufacturing graphite piece, which is to radiate the heat from chip, etc.

2. Description of the Prior Art

Graphite pieces are often applied to electric elements as processors, chips, etc. to conduct the heat generated from such electric elements.

The main ingredients of graphite piece are graphite and filler. Graphite is used to conduct heat, and filler makes the graphite piece soft to be processed. For some applications, the top and bottom surfaces of a graphite piece are formed as two sunken and convex surfaces by molds in order to match chips and other electric elements.

Referring to FIG. 1, which illustrates a schematic view of a bent graphite piece in prior arts. Prior art is that, a bent part 4 is stretched so as to make the density of the bent part 4 be obviously less than the density of a flat part 6 after bending the graphite piece 2. Thus, the heat conducting velocity of the bent part 4 will be lowered. In other words, the bent part 4 will be a negative part in the aspect of the graphite piece 2 conducting heat.

Moreover, referring to FIG. 2, which illustrates a schematic view of a radiating module in prior arts. FIG. 2 is the figure of a patent application with a publication number of US 2003/0116312 A1, and shows that a plurality of radiating components 14 are mounted on the top surface of the graphite piece 2. The prior art discloses an ideal embodiment to the radiating module 10, on the contrary, the radiating component 14 is hard to be firmly mounted on the soft graphite piece 2. Thus, any external force may damage the radiating module 10 very easily. Therefore, to solve the problems caused from the prior arts is an important issue to the skilled persons in the art.

### SUMMARY OF THE INVENTION

The present invention relates to a processing method for graphite piece, and particularly to a processing method for graphite piece of electric elements as processors, chips, etc.

The present invention is provided a processing method for graphite piece to promote efficiency of conducting and solve the problem of bending graphite piece with low density resulted in inefficiency. The other purpose of the present invention is in order to let the radiator firmly connected to the graphite piece.

The present invention relates to a processing method for graphite piece, the graphite piece having a specific figure, and comprising the steps of:

First, using a pair of male and female dies to sandwich a graphite material in between the pair of dies and cut the graphite material to become the graphite piece with the specific figure, wherein the graphite piece has a first thickness.

The male die and the female die continuously applying a force onto the graphite piece in order to form a predetermined second thickness by a backform disposed between the pair of male and female dies. It makes the density of graphite piece increase and promote the efficiency of conducting.

Moreover, after cutting the graphite material to become the graphite piece with the specific figure, the processing method further comprising the steps of:

The pair of male and female dies bending the graphite piece from the top and bottom surfaces of the graphite piece in order to form two sunken and convex surfaces. Forming the graphite piece with the second thickness is to make that the density of the bent portion of the graphite piece is approximate to the density of the flat portion of the graphite piece.

Furthermore, after cutting the graphite material to become the graphite piece with the specific figure, the processing method further comprising the steps of:

First, forming at least a first sunken area on the top surface of the graphite piece, and embedding the bottom of a radiator in the first sunken area, wherein the lateral of the bottom of the radiator has at least a second sunken area.

Then, the step of the male die and the female die continuously applying a force onto the graphite piece in order to form the predetermined second thickness is to make the first sunken area fall into the second sunken area in order to let the radiator is firmly connected to the graphite piece.

Therefore, the present invention uses the processing method for graphite piece of conducting heat from chips of electronic products. Applying a force onto the graphite piece is in order to form a thinner predetermined thickness by the backform disposed between the pair of male and female dies. It makes the density of graphite piece increase and promote the efficiency of heat conducting. Furthermore, applying a force can solve the problem of bending graphite piece with low density resulted in inefficiency. Moreover, applying a force can make the radiator firmly connected to the graphite piece.

### BRIEF DESCRIPTION OF THE DRAWINGS

The present invention will be more fully understood from the detailed description, which will be given hereinafter, with the aid of the illustrations below:

FIG. 1 shows a schematic view of a graphite piece for heat conduction after conventionally stamping;

FIG. 2 shows a schematic view of a conventional radiator;

FIG. 3 shows a flow chart of a processing method for graphite piece of the present invention;

FIG. 4 shows a schematic view of a graphite piece for heat conduction of the present invention;

FIG. 5 shows a cross-sectional schematic view of the mold of the FIG. 3 of the present invention;

FIG. 6 shows a flow chart of the upper and the lower surface of the graphite piece being concave and raised of the present invention;

FIG. 7 shows a schematic view of the mold structure of the FIG. 6 of the present invention;

FIG. 8 shows a flow chart of the radiator being embedded in the graphite piece for heat conduction of the present invention;

FIG. 9 shows a schematic view of the graphite piece of the FIG. 8;

FIG. 9 A-B-C shows schematic views of three preferred embodiments of the FIG. 9; and

FIG. 10 shows a flow chart of a processing method of using a graphite radiator of the present invention.

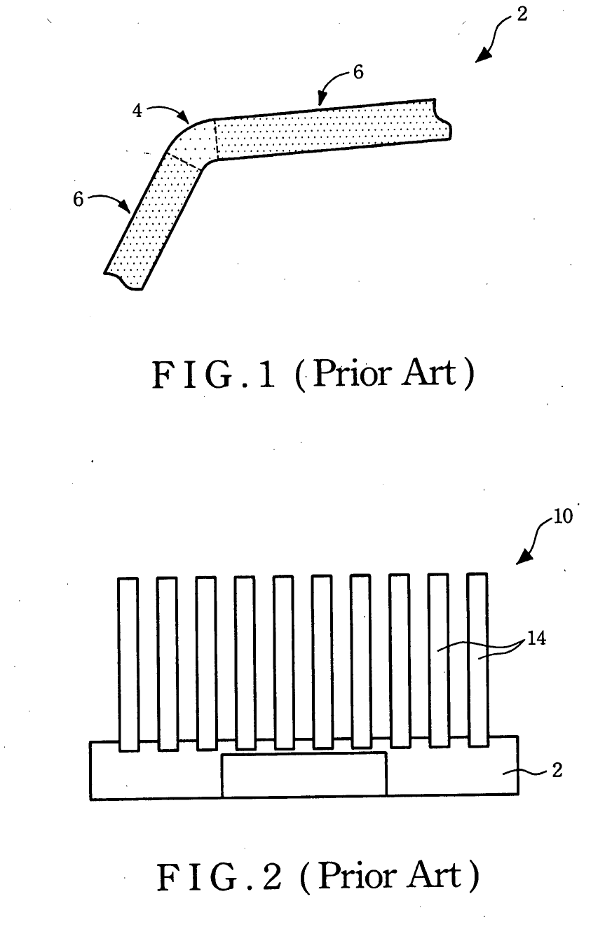

### DESCRIPTION OF THE PREFERRED EMBODIMENT

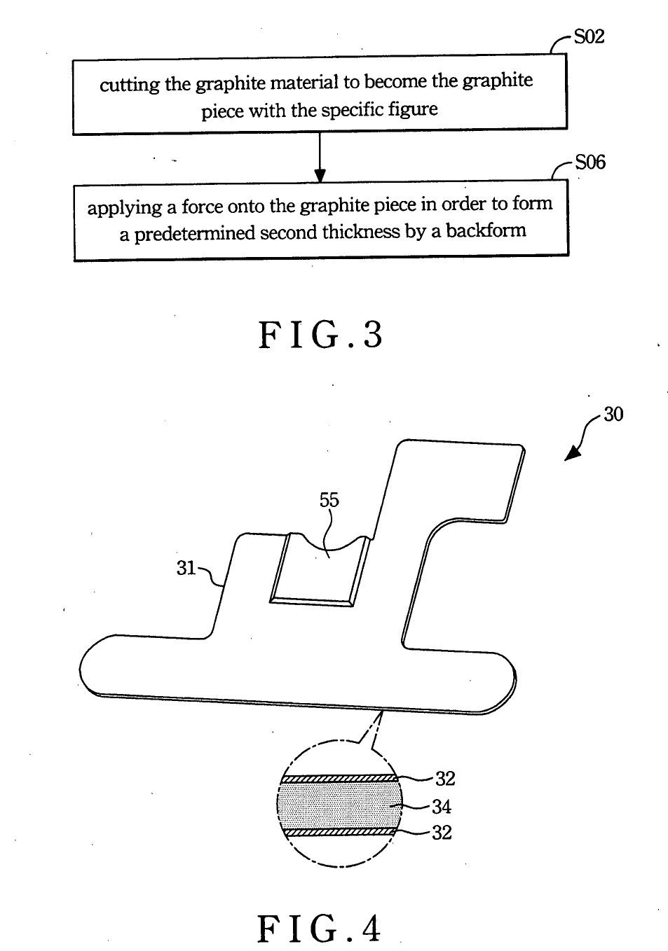

Referring to FIG. 3, which illustrates a flow chart of a processing method for graphite piece 30 of the present invention. The present invention is related to a processing method for graphite piece 30 having a specific FIG. 31 as FIG. 4. The graphite piece 30 is composed of a layer of graphite 34 sandwiched by two layer of aluminum foil 32. In fact, the graphite piece 30 can only consist of a layer of graphite 34 or partial aluminum foil 32 or whole aluminum foil 32 can be replaced by copper foil or back gel. Furthermore, the layer of graphite 34 consists of graphite used to conduct and filler which makes it soft to be processed.

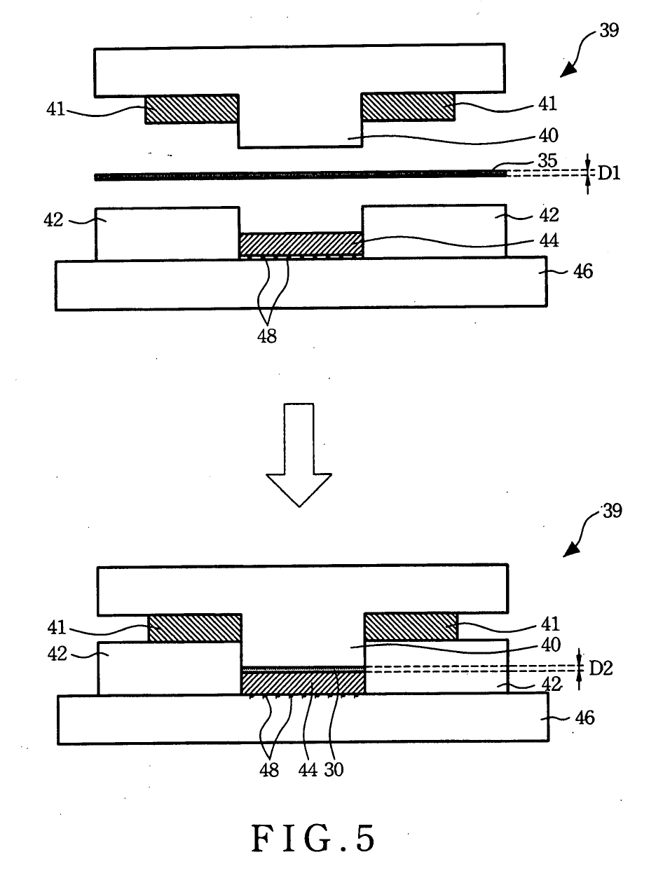

The processing method of the mold structure 39 of the FIG. 5 is stated as thereinafter. The mold structure 39 includes a male die 40 and a female die 42. The lateral of the male die 40 has a backform 41, the inside bottom of the female die 42 has a internal board 44, and the female die 42 and the internal board 44 both can be placed on a base board 46. Furthermore, an elastic element 48 as a spring can be placed between the internal board 44 and the base board 46, and the graphite material 35 is placed between the male die 40 and the female die 42.

Collocating FIG. 4, 5 to refer FIG. 3, comprising the steps of:

Step S02: First, using a pair of male 40 and female dies 42 to sandwich a graphite material 35 in between the pair of dies and cut the graphite material 35 to become the graphite piece 30 with the specific FIG. 31, wherein the graphite piece 30 has a first thickness D1.

Step S06: then, the male die 40 and the female die 42 continuously applying a force onto the graphite piece 30 (referring to FIG. 5, the male die 40 and the internal board 44 continuously applying a force onto the graphite piece 30) in order to form a predetermined second thickness D2 by a backform 41 disposed between the pair of male 40 and female dies 42 and make that the second thickness D2 less than the first thickness D1. The density of applying a force onto graphite piece 30 is larger so the effect of heat conduction of the graphite piece 30 is better.

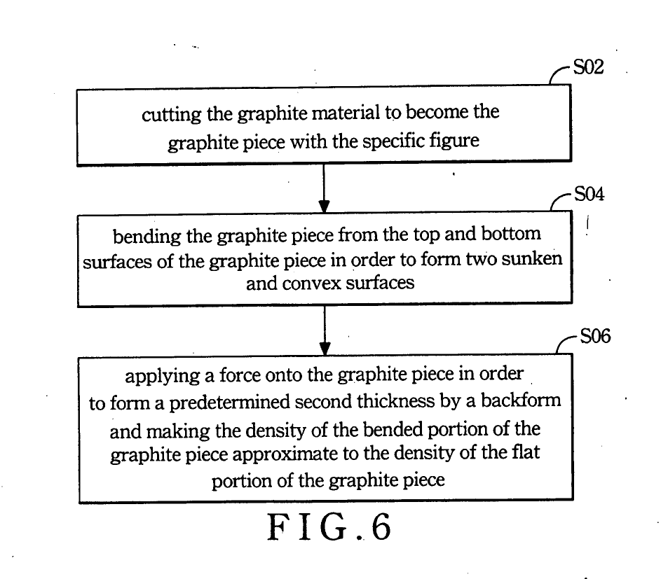

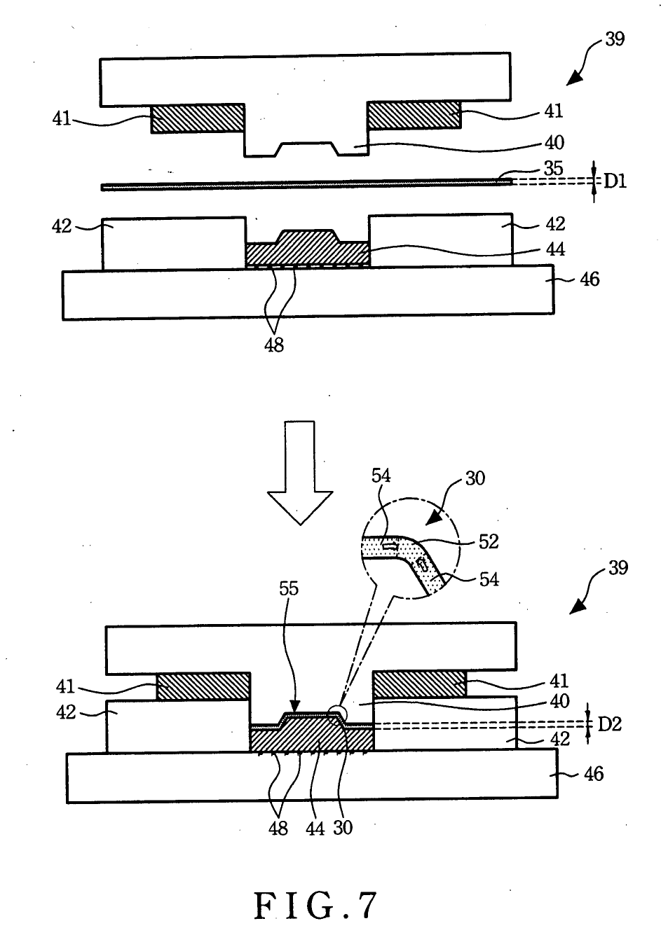

Referring to FIG. 6 and FIG. 7, FIG. 6 shows a flow chart of two sunken and convex surfaces of the graphite piece 30 of the present invention, and FIG. 7 shows a schematic view of the mold structure of the FIG. 6 of the present invention. The graphite piece 30 is applying a force as sunken and convex surfaces 55 (Referring to FIG. 2) in order to match the figure of chips and other electronic elements. As the statement of prior art, the bent portion 52 of sunken and convex surfaces 55 will make the density of graphite sparser, and the steps of FIG. 6 of the present invention will overcome the problems.

After cutting the graphite material to become the graphite piece 30 with the specific FIG. 31 as aforementioned step S02 of FIG. 6, the processing method further comprising the steps of:

Step S04: the pair of male 40 and female dies 42 bending the graphite piece 30 from the top and bottom surfaces of the graphite piece 30 in order to form two sunken and convex surfaces 55.

Continuously aforementioned step S06, the graphite piece 30 is applied to the predetermined second thickness D2 from the first thickness D1. Therefore, it not only increases the density of the graphite to promote the efficiency of heat conduction but also makes the density of the flat portion 54 of the graphite piece 30 applied to bent portion 52 to result in the density of the bent portion 52 of graphite piece 30 approaching the density of flat portion 54 with second thickness D2. It can avoid the difficult problems in bent portion of the prior art.

The processing method of the FIG. 6 matching up the mold structure 39 of the FIG. 7 states as thereinafter. Referring to FIG. 7, the internal board 46 of the inner bottom of the female die 42 is sunken and convex to match the bottom of the male die 40. Then, the male die 40 and the internal board 46 bend the graphite piece 30 from the two surface of the graphite piece 30 to in order to form two sunken and convex surfaces 55.

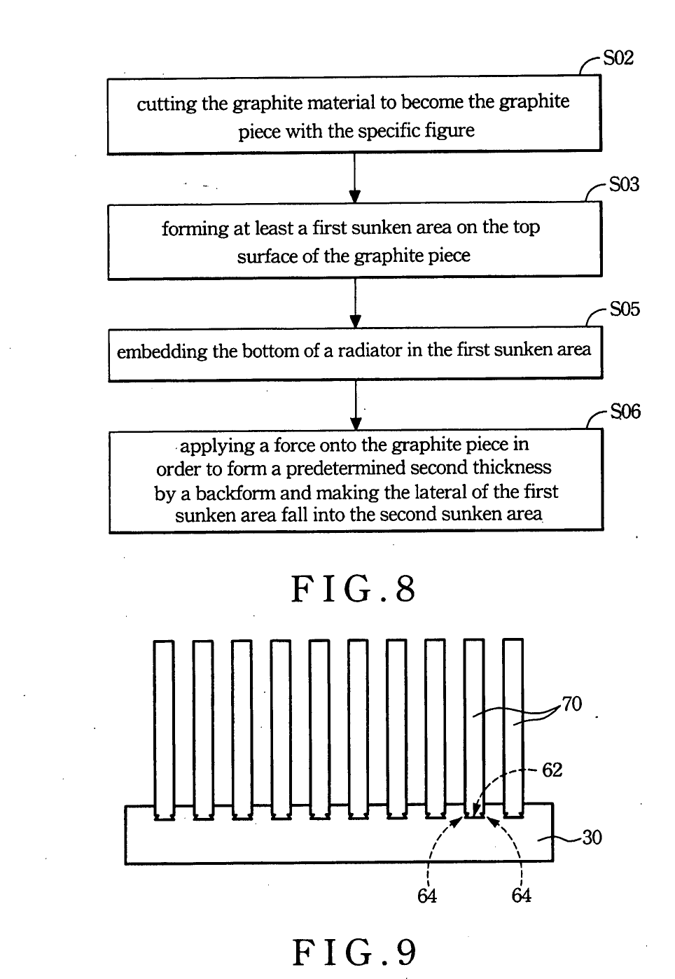

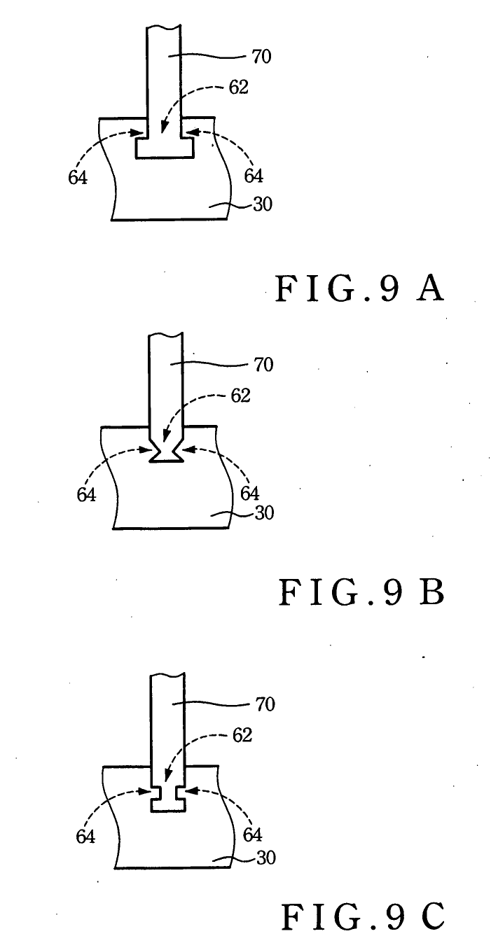

In addition, Referring to FIG. 8 and FIG. 9, FIG. 8 shows a flow chart of the radiator 70 being embedded in the graphite piece 30 of the present invention, and FIG. 9 shows a schematic view of the graphite piece 30 of the FIG. 8. as the illustration of FIG. 9, several radiators 70 are embedded in several first sunken areas 62 of the graphite piece 30. The bottom of each radiator 70 embedded in the lateral of the bottom of the first sunken areas 62 has at least a second sunken area 64. The figure of second sunken area 64 is as FIG. 9A, FIG. 9B, and FIG. 9C.

Referring to FIG. 8, after cutting the graphite material to become the graphite piece 30 with the specific FIG. 31 as aforementioned step S02, the processing method further comprising the steps of:

Step S03: first, forming at least a first sunken area 62 on the top surface of said graphite piece 30.
Step S05: then, embedding the bottom of a radiator 70 in the first sunken area 62, wherein the lateral of the bottom of the radiator 70 has at least a second sunken area 64.

Continuously aforementioned step S06, applying a force onto the graphite piece 30 in order to form the predetermined second thickness D2 through the aforementioned mold structure 39 not only makes the density of graphite increase but also make the first sunken area 62 fall into the second sunken area 64 in order to increase the efficiency of heat conduction and let the radiator 70 firmly connected to the graphite piece 30.

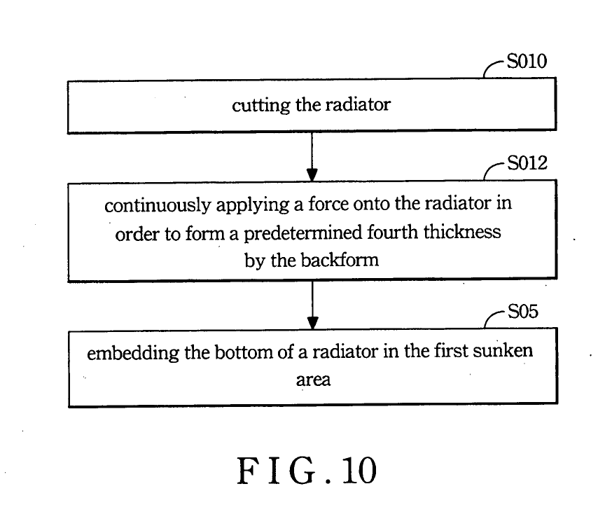

As the aforementioned statement, the material is made of metal or graphite. Referring to FIG. 10, it shows a flow chart of a processing method for graphite radiator 70 of the present invention. Before the bottom of the radiator 70 embedding in the first sunken areas 62 as aforementioned step S05, the processing method further comprising the steps of:

Step S010: using the pair of male 40 and female dies 42 to sandwich the radiator 70 in between the pair of dies and cut the radiator 70, wherein the radiator 70 has a third thickness.

Step S012: said male die 40 and said female die 42 continuously applying a force onto the radiator 70 in order to form a predetermined fourth thickness by the backform 41 disposed between the pair of male 40 and female dies 42 and make that the fourth thickness is not larger than the width of the first sunken area 62.

The aforementioned first sunken areas 62 can be a furrow or an indent. When the first sunken areas 62 is a furrow, the figure of the radiator 70 is a board. When the first sunken areas 62 is an indent, the figure of the radiator 70 is a column. The aforementioned radiator 70 is called a radiator fin in industrial circles. In the present invention, the figure of the radiator 70 is not being restricted as the figures, and it suits any figure.

As the aforementioned step S05, before the bottom of the radiator 70 being embedded in the first sunken areas 62, the radiator 70 can be applied an adhesive to embed in the first sunken area 62 more firmly.

In addition, besides the aforementioned graphite piece 30 is whole applied as the figures to increase the density of the graphite, the further step is to apply another force onto the part of the graphite piece 30, so that partial graphite piece 30 is still with the first thickness D1, and the part applied by force is formed to be with the predetermined second thickness D2, the density of the part with the second thickness D2 is larger than the density of the partial graphite piece 30 with the first thickness D1

The graphite piece 30 with the thin second thickness has better efficiency of heat conduction because of the density is larger. The graphite piece 30 with the thick first thickness has worse efficiency of heat conduction because of the density is lower. It suits in other field, but is also contained in the range of the present invention.

As a result, the processing method for graphite piece 30 of the present invention uses the backform 41 between the male die 40 and the female die 42 to apply a force onto the graphite piece 30 in order to form a predetermined less thickness to promote the efficiency of heat conducting. Furthermore, applying the bent graphite piece can solve the problem of the bent portion 52 of graphite with low density resulted in inefficiency. Moreover, the way of applying a force makes the radiator 70 firmly connected to the graphite piece 30.

As is understood by a person skilled in the art, the foregoing preferred embodiment of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

I claim:

1. A processing method for graphite piece, said graphite piece having a specific figure, and comprising the steps of:
using a pair of male and female dies to sandwich a graphite material in between the pair of dies and cut said graphite material to become said graphite piece with the specific figure, wherein said graphite piece has a first thickness; and
said male die and said female die continuously applying a force onto said graphite piece in order to form a predetermined second thickness by a backform disposed between said pair of male and female dies and make that the density of the graphite piece with the second thickness is larger than the density of the graphite piece with the first thickness.

2. The processing method according to claim 1, wherein after cutting said graphite material to become said graphite piece with the specific figure, said processing method further comprising the steps of:
the pair of male and female dies bending said graphite piece from the top and bottom surfaces of said graphite piece in order to form two sunken and convex surfaces;
wherein forming the graphite piece with the second thickness is to make that the density of the bent portion of the graphite piece is approximate to the density of the flat portion of the graphite piece.

3. The processing method according to claim 2, wherein the bottom of said female die has an internal board, said male die and said internal board bend said graphite piece from the top and bottom surfaces of said graphite piece in order to form the two sunken and convex surfaces.

4. The processing method according to claim 1, wherein said graphite piece comprises a graphite layer, and a coating layer of said graphite layer is selected from the group of aluminum foil, copper foil, and back gel.

5. The processing method according to claim 1, wherein after cutting said graphite material to become said graphite piece with the specific figure, said processing method further comprising the steps of:
Forming at least a first sunken area on the top surface of said graphite piece; and
embedding the bottom of a radiator in said first sunken area, wherein the lateral of said bottom of said radiator has at least a second sunken area;
wherein the step of said male die and said female die continuously applying a force onto said graphite piece in order to form the predetermined second thickness is to make the first sunken area fall into the second sunken area in order to let the radiator is firmly connected to the graphite piece.

6. The processing method according to claim 5, wherein said radiator is made of metal.

7. The processing method according to claim 5, wherein said radiator is made of graphite.

8. The processing method according to claim 7, wherein before embedding the bottom of a radiator in said first sunken area, said processing method further comprising the steps of:
using the pair of male and female dies to sandwich the radiator in between the pair of dies and cut the radiator, wherein said radiator has a third thickness; and
said male die and said female die continuously applying a force onto said radiator in order to form a predetermined fourth thickness by the backform disposed between said pair of male and female dies and make that the fourth thickness is not larger than the width of the first sunken area.

9. The processing method according to claim 5, wherein said first sunken area is a furrow, and the figure of said radiator is a board.

10. The processing method according to claim 5, wherein said first sunken area is an indent, and the figure of said radiator is a column.

11. The processing method according to claim 5, wherein the bottom of said radiator is applied an adhesive to embed in said first sunken area.

12. The processing method according to claim 1, wherein after said male die and said female die continuously applying a force onto said graphite piece in order to form the predetermined second thickness by the backform, the further step is to apply another force onto the part of the graphite piece, so that partial graphite piece is still with the first thickness, and the part applied by force is formed to be with the predetermined second thickness, the density of the part with the second thickness is larger than the density of the partial graphite piece with the first thickness.
